(19) United States
(12) Patent Application Publication
(10) Pub. No.: US 2004/0049420 A1
(43) Pub. Date: Mar. 11, 2004

(54) Electronic gift certificate system and method

(76) Inventors: Shareena Carlson, Burbank, CA (US); Richard V. Barrera, Fillmore, CA (US)

Correspondence Address: MILORD & ASSOCIATES, P.C., 10880 WILSHIRE BOULEVARD, SUITE 2070, LOS ANGELES, CA, 90024, US

(21) Appl. No.: 10/238,949

(22) Filed: Sep. 10, 2002

(51) Int. Cl. G06F 17/60

(52) U.S. Cl. 705/14

(57) ABSTRACT

An electronic gift certificate device and method that allows efficient access to the merchant issuing the same, wherein the buyer may include personalized indicia for the recipient viewing. In addition, the buyer may also include electronic text, graphics, video and audio files on the electronic gift certificate medium for the recipient's perusal.

### FIELD OF THE INVENTION

The present invention relates to the field of gift certificates, and more particularly to a gift certificate that is issued on a recorded medium that is delivered to a recipient that is able to provide access to a retail establishment that is preferably linked to the Internet.

### BACKGROUND OF THE INVENTION

Increasingly, consumers are gaining direct access to data bases for information and entertainment, whether through phone lines and coaxial cable or by wireless connections from cell systems and satellites. With this so-called “online” access, consumers can use data bases for a range of activities at virtually any time. Besides granting freedom to the consumer, online access gives added efficiencies to companies merchandising products and services, whether those products are sold directly to the consumer by mail or in a store.

In addition, due to increasing time constraints in the lives of busy people, certificates for use in obtaining goods or services have emerged as a viable alternative to the purchase of a gift. Certificates used as gift certificates offer many advantages over the purchase of a gift. If the gift giver is unsure of the needs of the recipient, a gift certificate offers a wide range of goods or services from which the recipient can choose. Gift certificates also remove the hassle of exchanging a gift without a receipt. Despite their pervasive use in the retail environment, gift certificates are often perceived as rather unexciting and uninspired gifts. Further, they are often viewed by the recipient as a means by which the giver can avoid spending too much effort in selecting an actual gift.

Several gift certificate issuing and redemption systems and methods are known. U.S. Pat. No. 5,870,718 to Spector discloses a computer-printer terminal adapted to produce under the control of its user a composite greeting and gift certificate card redeemable at a retail establishment which authorizes and is paid for the issuance of the certificate. The user prints out a gift certificate on the computer-printer terminal and delivers the same to the recipient. The print out gift certificate cannot store any audio or video and the certificate is discarded after redemption.

U.S. Pat. No. 6,175,823 to Van Dusen discloses a gift certificate system that distributes electronic gift certificates in the form of e-mail documents that include hyperlinks for automating the redemption process. When a gift certificate recipient clicks on such a hyperlink, the recipient's computer automatically transmits a claim code or other identification information to the merchant's Web site, and the site responds by automatically crediting the recipient's personal account with the gift certificate amount. When the recipient subsequently makes a purchase from the merchant's Web site, the recipient's account balance is automatically applied to the purchase price. The gift certificate is not as personalized as the issuer may wish and the gift certificate is discarded after redemption.

U.S. Pat. No. 6,193,155 to Walker et al. provides a method and apparatus for redeeming a gift certificate drawn on a credit card or other financial account. It discloses the step of receiving a gift certificate for payment of an identified value. The gift certificate, which is issued by an account issuer, includes thereon a certificate identifier corresponding to an account identifier. The account identifier identifies the financial account from which funds will be drawn to support the gift certificate transaction. When the gift certificate is redeemed, the issuer's financial account is contacted to further authorize the transaction. The gift certificate system of the invention is not personalized and the certificate is discarded after it is redeemed.

U.S. Pat. No. 5,954,194 to Simpson discloses a gift card that may also include a prerecorded video or audio device. Specifically, Simpson discloses a gift card that includes a gemstone therein in addition to a prerecorded DVD, VHS video-cassette, or a compact disc. The gift card of the invention is not customizable and gift card is discarded after the gemstone is removed.

U.S. Pat. No. 6,240,397 to Sachs discloses a gift certificate system wherein the giver generates a gift certificate including the value thereof, transmits the gift certificate to a recipient (e.g., via e-mail) without an indicia of the value of the gift certificate, and presents the recipient with only items to be purchased with the gift certificate whose value does not exceed the value of the gift certificate. In this manner, the recipient of the gift certificate is able to select an item to purchase with the gift certificate without knowing the exact value of the gift certificate. The giver may then be credited for the difference if the value of the item selected does not equal the total value of the gift certificate. This method may be too impersonal, the gift certificate may not be customized, and after the gift certificate is used, it is discarded.

Therefore, there remains a long standing and continuing need for an advance in the art that is simpler in both design and use, is more effective in allowing personalization of the gift certificate itself and allowing efficient and easy redemption thereof while containing information on the certificate storage medium such that it is not discarded.

### SUMMARY OF THE INVENTION

Accordingly, it is a general object of the present invention to overcome the disadvantages of the prior art.

In particular, it is an object of the present invention to provide a gift certificate system and method that is personalized by the issuer for the benefit of the recipient.

It is another object of present invention to provide a gift certificates system and method that allows easy redemption thereof by the recipient.

It is a further object of the present invention to provide a system for processing gift certificates whereby the redemption of a gift certificate is a dynamic, interactive, and flexible process for the redeemer.

It is yet another object of the present invention to provide a system for issuing gift certificates whereby the medium on which they are stored are still of value to the recipient even after redemption thereof such that promotional campaigns may be provided to benefit the issuing retailer.

It is a further object of the present invention to provide a system and method for issuing gift certificates that removes the impersonal stigma usually associated with a gift certificate.

In keeping with the principles of the present invention, a unique method and system of issuing gift certificates is disclosed which improves the efficiency and reliability of the redemption process. In accordance with the invention, a user creates a gift certificate from a specific retailer that is stored onto an electronic storage medium such as, but not limited to, a compact disc. In addition, the issuer may personalize the electronic storage medium by storing video, audio, or text files therein.

When a gift certificate recipient receives the storage medium and inserts the same into a computer, the computer automatically activates a web browser that accesses the retailer's website. A claim code or other identification information is sent to the retailer's website, and the site responds by automatically crediting a preexisting recipient's personal account with the gift certificate amount or allowing the recipient to establish a new account. When the recipient subsequently makes a purchase from the retailer's website, the recipient's account balance is automatically applied to the purchase price. An important benefit of this process is that it eliminates the need for the recipient to manually enter the claim code. Thus, the redemption process is simpler and more efficient for the gift certificate recipient. In addition, there is little or no risk that the user will submit an erroneous claim code.

In addition, the actual storage medium may be personalized by applying a visible message to the outer surface of the storage medium itself. In addition, audio, video, and text information may also be stored on the medium and accessed by the recipient.

Such stated objects and advantages of the invention are only examples and should not be construed as limiting the present invention. These and other objects, features, aspects, and advantages of the invention herein will become more apparent from the following detailed description of the embodiments of the invention when taken in conjunction with the accompanying drawings and the claims that follow.

### BRIEF DESCRIPTION OF THE DRAWINGS

It is to be understood that the drawings are to be used for the purposes of illustration only and not as a definition of the limits of the invention.

In the drawings, wherein similar reference characters denote similar elements throughout the several views:

FIGS. 1A & 1B illustrate a continuous flow chart illustrating a process for ordering a gift certificate.

FIG. 2 is a flow chart that illustrates a process for redeeming the issued gift certificate by the buyer and accessing other information stored on the storage medium.

FIG. 3 is an illustrative view of a graphic user interface that may be presented to the recipient of the gift certificate.

FIG. 4 is a top view of a preferred storage medium for the gift certificate.

### DETAILED DESCRIPTION OF THE INVENTION

It is to be understood that within the instant disclosure, the term “website” is used to refer to a user-accessible network site that implements the basic World Wide Web standards that are known in the art or that may later be implemented. Accordingly, the term “website” or a single specific example of the same is not intended to limit the invention to that specific website, but it is provided as an example of implementing the embodiments of the present invention without limiting the same.

The present invention provides an electronic gift certificate system which allows personalization of a gift certificate to remove the impersonal stigma associated therewith and also improves the efficiency and reliability of the redemption process. In accordance with one preferred embodiment of the invention, the system distributes gift certificates stored on electronic storage media that include hyperlinks for automating the redemption process, includes personalized messages electronically stored therein, and may include personalized messages directly applied to the surface of the storage media itself.

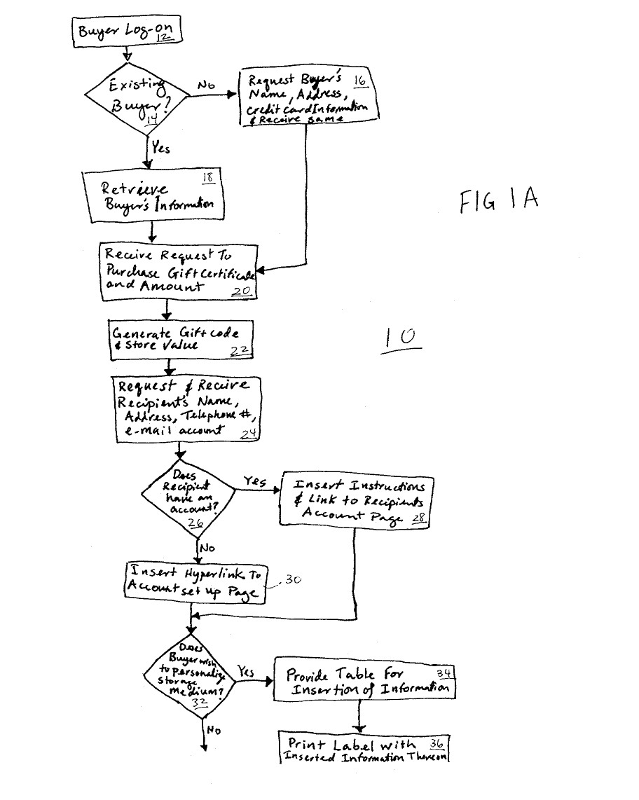

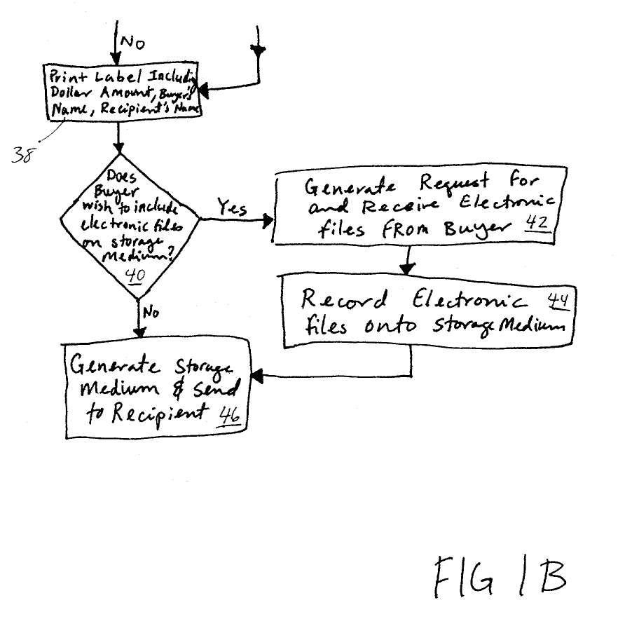

A preferred embodiment of the gift certificate system will now be described with reference to FIGS. 1 through 4. For purposes of illustration, the retail store website in the disclosed implementation is the website of amazon.com. The website includes an accounts database which stores information (names, e-mail addresses, billing information, etc.) about users that have previously made purchases from the site.

Now referring to FIGS. 1A and 1B specifically, a process generally designated as 10 is shown for ordering an electronic gift certificate. A buyer logs on to the website (12) and the database determines if the buyer is already a registered buyer (14). If the buyer is not an existing buyer, the system sends a registration form requesting the buyer's name, address, credit card information and receives the same (16). If the buyer is an existing buyer, then the buyer's information is received from the system (18). After the buyer's information is obtained, a request to purchase a gift certificate for a specific monetary amount is received (20). As a result, a unique gift code is generated and an appropriate record corresponding to the unique gift code is opened in a database (22). The buyer is requested to input the recipient's name, address, telephone number and e-mail account and the same is received therefrom (24). The database then determines whether the intended recipient has an account with the merchant (26). If the recipient is an existing customer, a link is inserted into the gift certificate storage medium directly linking to the recipient's account page (28). If the recipient does not have a preexisting account, a hyperlink is inserted to the account set up page of the merchant's website (30).

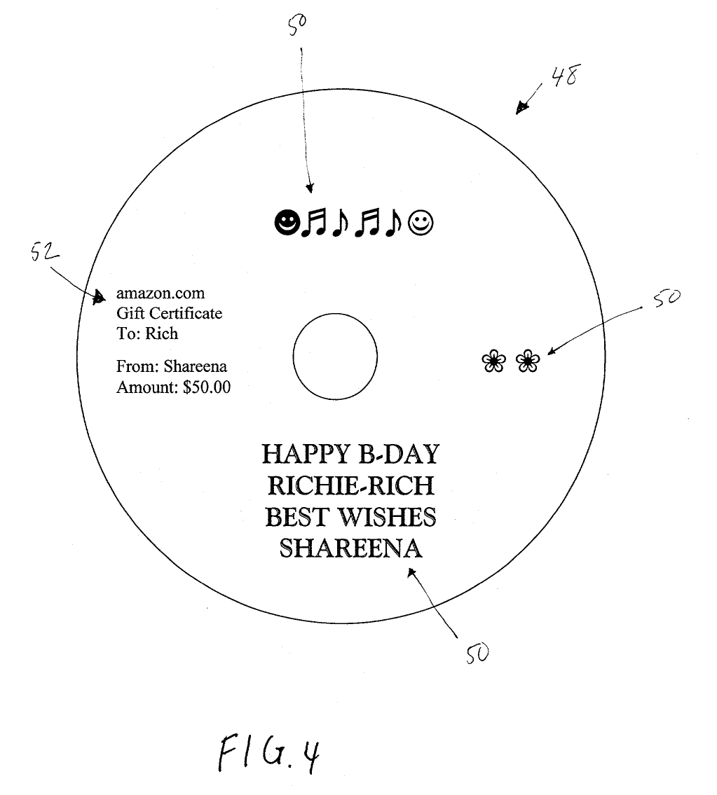

The buyer is then presented with an option to customize the outer surface of the storage medium (32). If the buyer wishes to personalize the outer surface of the storage medium, a table is provided for insertion of information (34). Now also referring to FIG. 4, the storage medium (48) may be a compact disc or any other electronic storage medium. Although, the storage medium (48) illustrated is circular, it is to be understood that other shapes may be substituted therefor. The buyer then may select indicia (50) that may be included on the outer surface of the storage medium (48). The indicia may be selected from graphics or text that exist on the merchant's website or may be uploaded to the site by the buyer so that it may be applied to the surface of the storage medium (48). Default indicia (52) will be included on the outer surface of the storage medium indicating the name of the merchant, the recipient's and buyer's names, and the amount of the gift certificate and will be included with any personalized indicia on the storage medium (36, 38).

The buyer is then queried whether the buyer would like to include electronic files on the storage medium (40). If the buyer chooses to include electronic files on the storage medium, the buyer may either upload the files to the merchant from the buyer's database or may download the file from the merchant's database (42). For example, the buyer may wish to upload a photograph of the buyer and the recipient onto the storage medium. As such the buyer may upload the photograph from the buyer's computer to the merchant's database. In addition, the buyer may wish to include a sound file, such as a song, that the recipient is fond of onto the storage medium. The buyer may either upload the song from the buyer's computer or download the song from the merchant's website for an additional fee. The electronic files are then recorded onto the storage medium (44) and the storage medium is sent to the recipient (46).

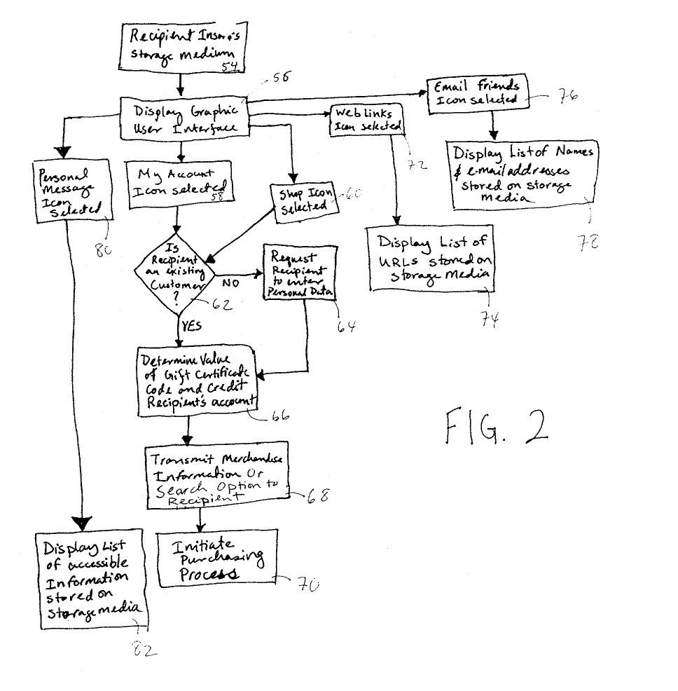

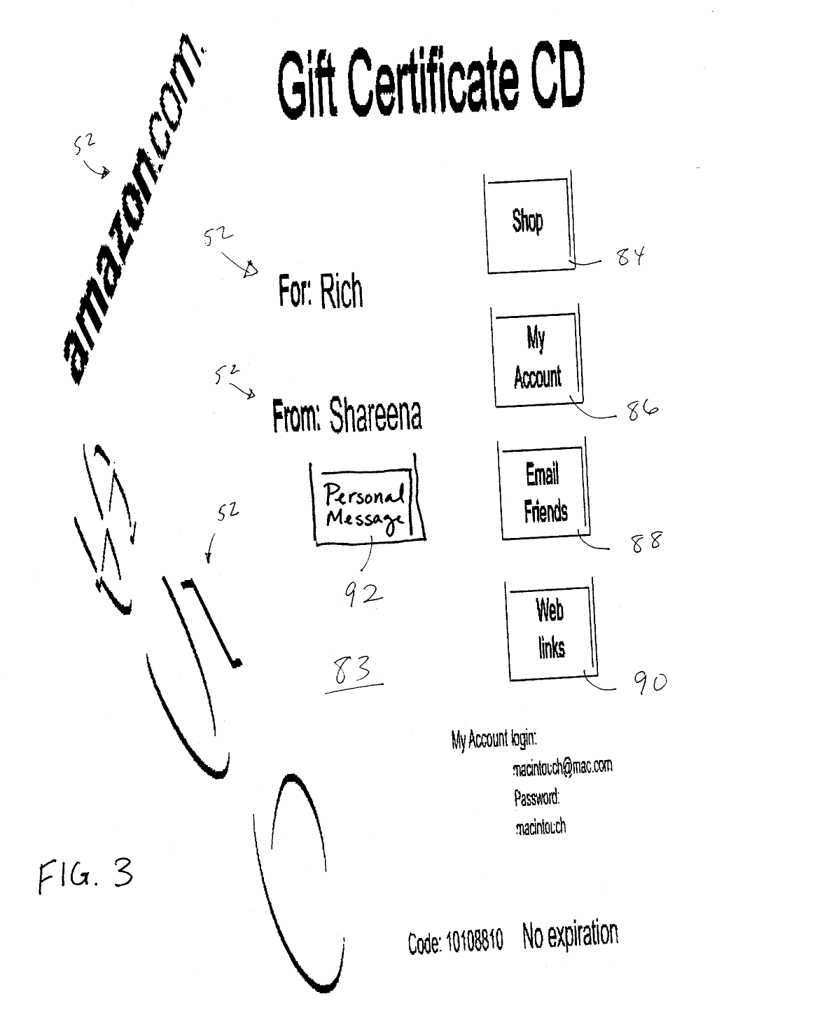

Now referring to FIGS. 2 and 3, the recipient of the storage medium inserts the same into a personal computer (54). A graphic user interface (83) is presented to the recipient (56). The graphic user interface (83) has indicia (52) thereon relaying basic information regarding the buyer, recipient, amount of the gift certificate, and the merchant. In addition, there are a plurality of actuation icons indicated by the numerals 84, 86, 88, 90, and 92 whose functioning is described in greater detail hereinafter.

If the recipient selects the shop icon (60), that is actuation icon (84), or selects the my account icon (58), actuation icon (86), a web browser application is opened and an inquiry is sent to the merchant database to the determine whether the recipient is an exiting customer (62). The URL (Uniform Resource Locator) associated with the hyperlinks contained in the actuation icons (84, 86) preferably include a gift certificate claim code that uniquely identifies the gift certificate. If the recipient is not a preexisting customer, a fillable request form is provided to the recipient to enter his or her personal data (64). After providing the personal data, or if recipient is an existing customer, the site automatically identifies and credit's the recipient's personal account (66). At this time the recipient may be provided a merchandise information page and/or a search option to search for available merchandise (68) and a purchase order may be processed (70) as is known in the art.

If the web links icon (90) is selected, a display of various hyperlinks having URLs that are associated with the merchant may be presented to the recipient (72, 74). As such, alternate merchants that are listed on the web links icon (90) may also be able to redeem the gift certificate. If the Email friends icon (88) is selected, a list of names and e-mail addresses of friends of the buyer and recipient may be presented (76, 80). If the personal message icon (92) is selected, a list of accessible information that was caused to be stored on the medium by the buyer will be presented to the recipient. As such the recipient will be able to listen to audio, video, or graphics files stored thereon.

The basic hardware and software components that are typically invoked during the above-described process are generally known in the art. In addition, while Internet based access has been described above the invention is not thus limited. The invention may be practiced, for example, by using a computer control system associated with a vending machine, or an automatic teller machine (ATM) of the type operated by banks and the like. Both vending machines and ATM machines include displays and user-input devices sufficient to the practice of the invention.

While the above description contains many specificities, these should not be construed as limitations on the scope of the invention, but rather as exemplifications of preferred embodiments thereof. Many other variations are possible without departing from the essential spirit of this invention. Accordingly, the scope of the invention should be determined not by the embodiments illustrated, but by the appended claims and their legal equivalents.

What is claimed is:

1. An electronic gift certificate device, comprising:
an electronic storage medium;
a gift certificate code stored within the medium that is relayed to a merchant's database;
whereby, an account corresponding with said gift certificate code allows a recipient to make purchases from items stored on said merchant's database.

2. The device of claim 1, wherein at least an electronic file may be recorded onto said storage medium by the buyer of said gift certificate.

3. The device of claim 2, wherein said electronic file may be selected from a group of files consisting of graphics, text, audio, and video.

4. The device of claim 2, wherein said electronic file may be a picture stored as an image file.

5. The device of claim 2, wherein said electronic file may be a video clip stored as a video file.

6. The device of claim 2, wherein said electronic file may be a song stored as an audio file.

7. The device of claim 1, wherein a plurality of Uniform Resource Locaters are provided to alternate merchants that would be able to redeem the gift certificate.

8. The device of claim 1, wherein a list of personal contacts are stored on said medium such that the recipient may contact the same by electronic mail.

9. The device of claim 3, wherein said electronic file includes a picture stored as an image file;
a video clip stored as a video file;
a song stored as an audio file; and
a textual message stored as a text file.

10. The device of claim 2, wherein indicia may be adorned onto a surface of said storage media.
